(19) United States
(12) Patent Application Publication
(10) Pub. No.: US 2026/0296191 A1
(43) Pub. Date: Oct. 1, 2026

(54) SYSTEMS AND METHODS FOR VEHICLE OCCUPANCY BASED MEDIA RECOMMENDATION

(71) Applicant: Toyota Motor Engineering & Manufacturing North America, Inc., Plano, TX (US)

(72) Inventors: Michael R. Kushnerik, Canton, MI (US); Timothy Wang, Ann Arbor, MI (US); Roger Akira Kyle, Aubrey, TX (US); Bryan Else Yamasaki, Aubrey, TX (US); Justin K. Shen, Canton, MI (US); Xiao Xu, Novi, MI (US); Jackson Zhu, Plano, TX (US)

(73) Assignees: Toyota Motor Engineering & Manufacturing North America, Inc., Plano, TX (US); Toyota Jidosha Kabushiki Kaisha, Toyota-shi (JP)

(21) Appl. No.: 19/090,092

(22) Filed: Mar. 25, 2025

(51) Int. Cl. B60K 35/28; G06V 20/59; H04N 21/454

(52) U.S. Cl. CPC B60K 35/28; G06V 20/59; H04N 21/454

(57) ABSTRACT

Methods, systems, and devices for recommending media based on a vehicle's occupants. The method may include detecting or determining, via one or more occupant sensors, occupant data indicating a classification of occupants within the vehicle. The method may further include determining, via an electronic control device (ECU) electrically connected to the one or more occupant sensors and an in-vehicle infotainment platform, whether media is playing inside the vehicle. The method may further include determining, via the ECU, whether a child is inside the vehicle from the classification of occupants in the occupant data. The method may further include, upon determining a child is inside the vehicle, determining, from a media database, whether the media is rated for adults. The method may further include, when the media is rated for adults, transmitting one or more signals to the in-vehicle infotainment platform to pause the media and display a content warning.

### BACKGROUND

### 1. Field

The present disclosure relates to systems and methods for generating a vehicle occupancy-based media recommendation.

### 2. Description of the Related Art

Various technologies related to aged-based media have been adapted. For example, media applications may have a “Kids only” mode which may include only content appropriate for children. Some other media applications may offer settings to avoid playing and/or recommending certain types of media that may not be appropriate for children. However, vehicles currently do not offer many options for filtering media played on the vehicle's infotainment system, which can cause concerns if adult media is played when there are children occupants inside the cabin.

Accordingly, there is a need to better allow for occupancy-based media recommendations in a vehicle.

### SUMMARY

Described herein is a system for recommending media based on a vehicle's occupants. In one aspect, the system may include one or more occupant sensors configured to detect or determine occupant data indicating a classification of each occupant within the vehicle, the classification being an adult or a child. The system also may include an in-vehicle infotainment platform configured to play media inside the vehicle. The system also may include a media database storing age ratings for media playable via the in-vehicle infotainment platform. The system also may include a network access device configured to facilitate communication between the media database and the vehicle. The system also may include an electronic control unit (ECU) electrically connected to the one or more occupant sensors, the in-vehicle infotainment platform, and the network access device and configured to (1) determine media is playing inside the vehicle via the in-vehicle infotainment platform, (2) receive the occupant data from the one or more occupant sensors, (3) determine the occupant data indicates a child is inside the vehicle, (4) receive media data, via the network access device, from the media database corresponding to the media playing inside the vehicle, (5) upon determining a child is inside the vehicle, determine, from the media data, whether the media is rated for adults, and (6) when the media is rated for adults, transmit one or more signals to the in-vehicle infotainment platform to pause the media and display a content warning.

In one aspect, the subject matter may be embodied in a vehicle including a system for recommending media based on a vehicle's occupants. The vehicle may include one or more occupant sensors configured to detect or determine occupant data indicating a classification of each occupant within the vehicle. The vehicle also may include an in-vehicle infotainment platform configured to play media inside the vehicle. The vehicle also may include a media database storing age ratings for media. The vehicle also may include an electronic control unit (ECU) electrically connected to the one or more occupant sensors, the in-vehicle infotainment platform, and the media database and configured to (1) determine media is playing inside the vehicle via the in-vehicle infotainment platform, (2) receive the occupant data from the one or more occupant sensors, (3) determine the occupant data indicates a child is inside the vehicle, (4) upon determining a child is inside the vehicle, determine, from the media database, whether the media is rated for adults, (5) when the media is rated for adults, transmit one or more signals to the in-vehicle infotainment platform to pause the media and prompt a user to change the media to media rated for children, (6) receive a response to the prompt from the user to change the media to media rated for children, and (7) transmit one or more signals to the in-vehicle infotainment platform to change the media to media rated for children.

In one aspect, the subject matter may be embodied in a method for recommending media based on a vehicle's occupants. The method may include detecting or determining, via one or more occupant sensors, occupant data indicating a classification of occupants within the vehicle. The method may further include determining, via an electronic control device (ECU) electrically connected to the one or more occupant sensors and an in-vehicle infotainment platform, whether media is playing inside the vehicle. The method may further include determining, via the ECU, whether a child is inside the vehicle from the classification of occupants in the occupant data. The method may further include, upon determining a child is inside the vehicle, determining, from a media database, whether the media is rated for adults. The method may further include, when the media is rated for adults, transmitting one or more signals to the in-vehicle infotainment platform to pause the media and display a content warning.

### BRIEF DESCRIPTION OF THE DRAWINGS

Other systems, methods, features, and advantages of the present disclosure will be apparent to one skilled in the art upon examination of the following figures and detailed description. Component parts shown in the drawings are not necessarily to scale and may be exaggerated to better illustrate the important features of the present disclosure. In the drawings, like reference numerals designate like parts throughout the different views.

FIG. 1 is a block diagram illustrating a vehicle having a system for recommending media based on a vehicle's occupants according to an aspect of the disclosure.

FIG. 2 is a view of an example interior of a vehicle including the system for recommending media based on a vehicle's occupants according to an aspect of the disclosure.

FIG. 3 is a flowchart illustrating a method for recommending media based on a vehicle's occupants according to an aspect of the disclosure.

### DETAILED DESCRIPTION

Disclosed herein are systems and/or methods for recommending media in a vehicle based on the vehicle's occupants. The occupancy-based media recommendation system may first detect the presence of occupants in the cabin of the vehicle and the occupant's classification (e.g., age) and location within the vehicle. Once the occupancy-based media recommendation system has determined this occupant information, the system can then check if there is media being played in the vehicle. If so, the occupancy-based media recommendation system can identify if the media matches the age ratings of the occupants in the cabin. If children are in the cabin and adult media is being played, the system can pause the media and recommend a driver or passenger to switch to other media rated for children. If this recommendation is rejected, the system may disable the child mode and play the adult media or adjust the volume of the adult media in the cabin zone of the child using directional/localized audio.

Particular aspects of the subject matter described herein may be implemented to realize one or more of the following advantages. Ensuring children are only exposed to age-appropriate media is a concern faced by many parents. Oftentimes media that is inappropriate for children may come on in a vehicle while an adult is driving. While driving, it is difficult for the adult to change the media, especially to media specifically appropriate for children as it may distract them from the task of driving and/or may be difficult to accomplish while driving. For example, the driver may need to open their phone or interact with the infotainment system in order to search for and select age-appropriate media. In some cases, the adult may not realize or may not hear that the media is inappropriate for children, for example if there are other noises covering the sound of the media or the driver is simply focusing on driving and not listening to the media. However, the child in the vehicle may nonetheless hear the inappropriate content. By utilizing an interior occupant detection system (e.g., weight-based, radar-based, camera-based, etc.) to detect the presence of occupants in the cabin, their classification (e.g., child vs. adult) and their location (e.g., which seat), the system described herein can allow for detecting the presence of child occupants in the vehicle and appropriately censoring the played media if the media is not appropriate for a child of the determined classification. In this way, the system can both detect that there is inappropriate media playing in the presence of a child and prompt the driver (or other adult passenger) to change the media to age-appropriate media. This can help the driver to stay focused on the task of driving and prevent distracted driving, as well as prevent children from hearing inappropriate media in a vehicle.

An exemplary system for recommending media based on a vehicle's occupants is disclosed herein. The system may include one or more occupant sensors configured to detect or determine occupant data indicating a classification of each occupant within the vehicle, the classification being an adult or a child. The system also may include an in-vehicle infotainment platform configured to play media inside the vehicle. The system also may include a media database storing age ratings for media playable via the in-vehicle infotainment platform. The system also may include a network access device configured to facilitate communication between the media database and the vehicle. The system also may include an electronic control unit (ECU) electrically connected to the one or more occupant sensors, the in-vehicle infotainment platform, and the network access device and configured to (1) determine media is playing inside the vehicle via the in-vehicle infotainment platform, (2) receive the occupant data from the one or more occupant sensors, (3) determine the occupant data indicates a child is inside the vehicle, (4) receive media data, via the network access device, from the media database corresponding to the media playing inside the vehicle, (5) upon determining a child is inside the vehicle, determine, from the media data, whether the media is rated for adults, and (6) when the media is rated for adults, transmit one or more signals to the in-vehicle infotainment platform to pause the media and display a content warning.

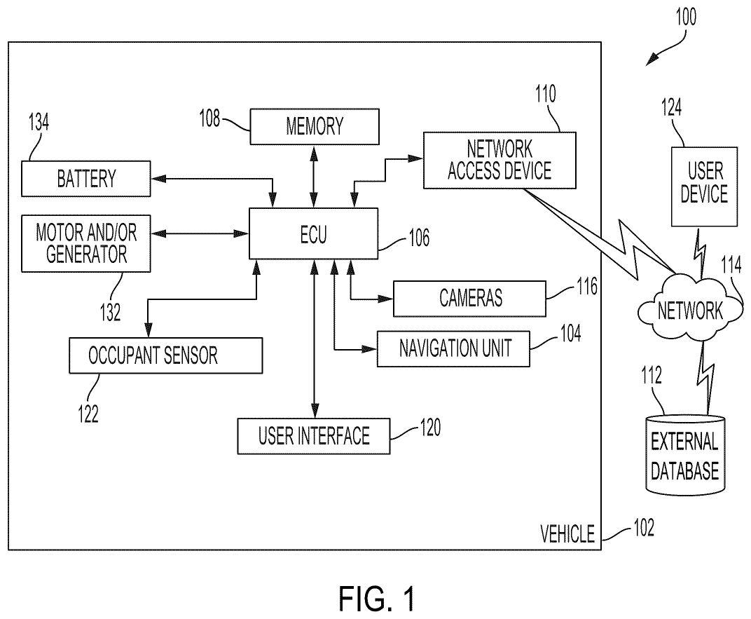

FIG. 1 is a block diagram of an example occupancy-based media recommendation system 100. The occupancy-based media recommendation system 100 or a portion thereof may be retrofitted, coupled to, include, or be included within a vehicle 102 or separate from the vehicle 102. The vehicle 102 may be a conveyance capable of transporting a person, an object, or a permanently or temporarily affixed apparatus. The vehicle 102 may be a self-propelled wheeled conveyance, such as a car, a sports utility vehicle, a truck, a bus, a van or other motor, battery or fuel cell driven vehicle. For example, the vehicle 102 may be an electric vehicle, a hybrid vehicle, a hydrogen fuel cell vehicle, a plug-in hybrid vehicle or any other type of vehicle that has a fuel cell stack, a motor, an engine, and/or a generator. Other examples of vehicles include bicycles, trains, planes, or boats, and any other form of conveyance that is capable of transportation. The vehicle 102 may be semi-autonomous or autonomous. That is, the vehicle 102 may be self-maneuvering and navigate without human input. An autonomous vehicle may have and use one or more sensors and/or a navigation unit to drive autonomously.

The occupancy-based media recommendation system 100 may couple, connect to, or include an external database 112. The occupancy-based media recommendation system 100 may have a network 114 that links the external database 112 with the vehicle 102. The network 114 may be a local area network (LAN), a wide area network (WAN), a cellular network, the Internet, or combination thereof, that connects, couples and/or otherwise communicates between the vehicle 102 and the external database 112.

The vehicle 102 may include a motor and/or generator 132 and/or a battery 134. The motor and/or generator 132 may be located within an engine bay of the vehicle 102. The motor and/or generator 132 may be an internal combustion engine (ICE). In this regard, the motor and/or generator 132 may combust an air and fuel mixture to provide power to the vehicle 102 and/or components of the vehicle 102 and/or the occupancy-based media recommendation system 100. Accordingly, the motor and/or generator 132 can cause the vehicle 102 to accelerate, decelerate, or maintain a desired velocity. The motor and/or generator 132 may include combinations of an ICE and an electric motor, such as for hybrid electric vehicle (HEV) applications, for example. In examples, the motor and/or generator 132 may be an electric motor. In this regard, the motor and/or generator 132 may be an electric motor and an electric generator that converts electrical energy into mechanical power, such as torque, and converts mechanical power into electrical energy. The motor and/or generator 132 may be electrically connected to the battery 134. The motor and/or generator 132 may convert energy from the battery 134 into mechanical power, and may provide energy back to the battery 134, for example, via regenerative braking. The battery 134 may be electrically connected to the motor and/or generator 132 and may provide electrical energy to and/or receive electrical energy from the motor and/or generator 132. The battery 134 may provide electrical energy to the occupancy-based media recommendation system 100.

The occupancy-based media recommendation system 100 and/or the vehicle 102 may further include one or more processors, such as an electronic control unit (ECU) 106. The ECU 106 may be implemented as a single ECU or in multiple ECUs. The ECU 106 may be electrically connected to some or all of the components of the vehicle 102 and/or the occupancy-based media recommendation system 100 (e.g., via a controller area network (CAN) bus and/or other protocols). The ECU 106 may include one or more processors (or controllers) specifically designed for controlling operations of the vehicle 102, such as accelerating, braking, controlling a panoramic view monitor (PVM) system of the vehicle 102 (e.g., one or more cameras 116), etc. In examples, the ECU 106 may be and/or include an advanced driver assistance systems (ADAS) sensor fusion ECU, a panoramic view monitor (PVM) ECU, an engine control module (ECM), a transmission control module (TCM), a telematics control unit (TCU), an in-vehicle infotainment (IVI) ECU, and/or a graphics processing unit (GPU).

The occupancy-based media recommendation system 100 and/or the vehicle 102 may further include a memory 108. The memory 108 may be electrically connected to the ECU 106. In examples, the memory 108 may be communicatively coupled (e.g., via a network 114) to the ECU 106 such that the memory 108 is remote from the ECU 106 and/or the vehicle 102. In other examples, the memory 108 may be electrically connected to the ECU 106 and a remote memory (e.g., a remote database) may be communicatively coupled to the ECU 106, with the remote memory having similar, additional, and/or different functions as the memory 108 (e.g., greater storage capacity, enabling over-the-air updates, etc.). The memory 108 may store instructions to execute on the ECU 106 and may include one or more of a random access memory (RAM) or other volatile or non-volatile memory. The memory 108 may be a non-transitory memory or a data storage device, such as a hard disk drive, a solid-state disk drive, a hybrid disk drive, or other appropriate data storage, and may further store machine-readable instructions, which may be loaded and executed by the ECU 106.

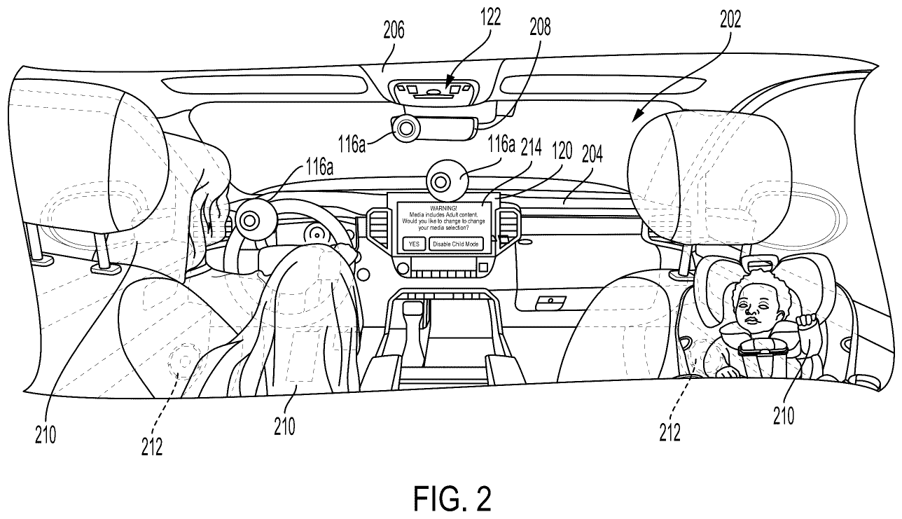

The occupancy-based media recommendation system 100 and/or the vehicle 102 may further include a user interface 120. The user interface 120 may be located within a cabin 202 (marked in FIG. 2) of the vehicle 102 and/or may be coupled to a dashboard 204 (marked in FIG. 2) of the vehicle 102. The user interface 120 may provide an interface to a user (e.g., a driver and/or a passenger) of the vehicle 102 to interact with and/or receive output from the ECU 106. The user interface 120 may have a user interface element, such as one or more screens and/or one or more touchscreens with a button, a switch, a microphone, a speaker, a gesture monitoring sensor, a knob, a graphical user interface (GUI), and/or other input/output devices electrically connected to the ECU 106 to provide input and/or output of information (or data) to and/or from the ECU 106. The user interface 120 may allow the user of the vehicle 102 to interact with and/or control (via the ECU 106) the multimedia systems and/or infotainment systems (e.g., including audio) of the vehicle. The ECU 106 can include hardware and software that controls the multimedia systems and/or infotainment systems (e.g., including audio) of the vehicle.

The occupancy-based media recommendation system 100 and/or the vehicle 102 may further include a navigation unit 104. The navigation unit 104 may be electrically connected to the ECU 106. The navigation unit 104 may provide vehicle information (or data) and/or navigational map information to the ECU 106. The navigation unit 104 may have and/or be connected to a Global Positioning System (GPS) device. The vehicle information may include a current speed, position, location, and/or orientation of the vehicle 102, and/or a direction of travel of the vehicle 102.

The occupancy-based media recommendation system 100 and/or the vehicle 102 may further include a network access device 110. The network access device 110 may be electrically connected to the ECU 106 and may include a communication port or channel, such as one or more of a Wi-Fi unit, a Bluetooth® unit, a Radio Frequency Identification (RFID) tag or reader, a DSRC unit, and/or a cellular network unit for accessing the network 114 (e.g., CDMA, GSM, 3G, 4G, 5G, etc.). The network access device 110 may transmit data to and receive data from devices and systems not directly connected to the vehicle 102. For example, the network access device 110 may communicate with an external database 112 (e.g., via radio frequency (RF) signals, infrared (IR) signals, etc.) and/or via the network 114. The network access device 110 may be configured to communicate with a user device 124 (e.g., a phone, a tablet, a laptop, a computer, etc.) via the network 114. In examples, the user device 124 may have some or all of the features of the user interface 120 (e.g., providing input and/or output of information (or data) to and/or from the ECU 106, such as the user input data).

The occupancy-based media recommendation system 100 may include or be coupled to the external database 112. A database is any collection of pieces of information that is organized for search and retrieval, such as by a computer, and the database may be organized in tables, schemas, queries, reports, or any other data structures. A database may use any number of database management systems. The external database 112 may include a third-party server or website that stores or provides information. The information may include real-time information, periodically updated information, or user-inputted information. A server may be a computer in a network that is used to provide services, such as accessing files or sharing peripherals, to other computers in the network.

The external database 112 may be a relational database or behavioral model database that provides models of normal motions and/or features of different passengers and/or characteristics of media, such as whether the media contains content inappropriate for children. The external database 112 may be updated and/or provide updates in real-time. The external database 112 may store and/or provide the models to the ECU 106. The external database 112 may also store human characteristic information, such as average height and/or weight based on age and provide the characteristic information to the ECU 106 to assist in determining a classification (e.g., child versus adult) of a passenger in the vehicle. The human characteristic information may include the average height and/or weight by age, facial characteristics typical of an adult versus a child, and/or other characteristic information that may affect the determination. The external database 112 may also store information related to the media playing inside the vehicle, such as age ratings for each media.

FIG. 2 is an illustration of the cabin 202 of the vehicle 102. Within the cabin 202 of the vehicle 102 may be one or more occupants 210. Referring to FIG. 2 with continuing reference to FIG. 1, the occupancy-based media recommendation system 100 and/or the vehicle 102 may further include one or more occupant sensors 122. The one or more occupant sensors 122 may be electrically connected to the ECU 106. The one or more occupant sensors 122 may be and/or include one or more cameras, one or more radar sensors, one or more lidar sensors, one or more sonar sensors, one or more weight (or pressure) sensors, and/or one or more seatbelt sensors. In examples, the one or more occupant sensors 122 may be and/or include a cabin awareness system (CAS). The one or more occupant sensors 122 may be coupled to a ceiling 206 of the cabin 202 as shown in FIG. 2. However, in examples, in addition to and/or as an alternative to the ceiling 206, the one or more occupant sensors 122 may be coupled to the dashboard 204 of the vehicle 102 and/or to one or more seats of the vehicle (e.g., when the one or more occupant sensors 122 include the one or more weight sensors and/or the one or more seatbelt sensors).

The one or more occupant sensors 122 may be configured to detect and/or determine occupant data. The occupant data may indicate and/or include a number (or quantity) of occupants (e.g., one, two, three, etc.) that are within the vehicle 102 (e.g., the number of occupants that are within the vehicle 102 before the vehicle 102 is parked and the number of occupants exit the vehicle 102), a location of the occupants in the vehicle 102, and the classification (e.g., child or adult) of the occupants that are within the vehicle 102. To detect and/or determine the occupant data, the one or more occupant sensors 122 may be configured to detect and/or determine whether an occupant is within each respective seat of the vehicle 102 and what the classification of each occupant is within the vehicle 102. In examples, the one or more occupant sensors 122 may detect image, radar, lidar, and/or sonar data to detect and/or determine whether an occupant is within each respective seat of the vehicle 102 and the corresponding classification of each occupant. In examples, the one or more occupant sensors 122 may provide the detected image, radar, lidar, and/or sonar data to the ECU 106 and the ECU 106 may determine the occupant data based on the received detected image, radar, lidar, and/or sonar data.

For example, the one or more occupant sensors 122 may detect and/or determine that an occupant is within a respective seat of the vehicle 102 and a classification of the occupant when a predetermined weight (e.g., more than or equal to 20 pounds, 30 pounds, etc.) is detected and/or measured on the respective seat, when a seatbelt of the respective seat is buckled and/or unbuckled, and/or when the detected image, radar, lidar, and/or sonar data indicates that an occupant is within the respective seat. In examples, the predetermined weight may be stored in the memory 108 and/or may be selected by the user (e.g., via the user interface 120 and/or the user device 124). The one or more occupant sensors 122 and/or the ECU 106 may utilize the detected image, radar, lidar, and/or sonar data in computer vision algorithms and/or distance calculations to detect and/or determine the classification of an occupant the vehicle 102.

The occupancy-based media recommendation system 100 and/or the vehicle 102 may further include one or more cameras (or object sensors) 116. In examples, the one or more cameras 116 may be and/or include a panoramic view monitor (PVM) system. For example, the one or more cameras 116 may include one or more internal cameras 116a. The one or more internal cameras 116a may be electrically connected to the ECU 106. The one or more internal cameras 116a may include multiple cameras positioned within the vehicle 102 to capture different views within the cabin of the vehicle 102, as shown in FIG. 2 for example. The one or more internal cameras 116a may be positioned within the vehicle 102, such as on the rearview mirror 208 or on the dashboard 204. The one or more internal cameras 116a may capture image that includes a single frame or image or a continuous video of the environment inside or within the vehicle 102. The different views within the vehicle may be used to form the panoramic or 360-degree image of the entire cabin, which allows the occupancy-based media recommendation system 100 to capture images of the occupants within the vehicle 102.

In examples, the ECU 106 may be configured to determine the classification of the occupants based on the received video data. For example, the ECU 106 may use computer vision algorithms to process and/or analyze the video data to determine an approximate age or age range of the occupants. In examples, when the ECU 106 determines that an occupant of the vehicle 102 is a certain classification (e.g. a baby, a child, an adult, a senior, a dog, etc.), the ECU 106 may deactivate (or turn off) or change the media playing inside the vehicle 102 or prompt the user to change the media playing inside the vehicle 102 if the media is inappropriate for an occupant of that classification.

The ECU 106 may further determine whether there is media playing inside the vehicle 102 (e.g., through the speakers 212). If so, the ECU 106 may determine if there are children of a certain age in the vehicle 102, as described above. In examples, the ECU 106 may determine an approximate age range of each of the occupants 210 in the vehicle, such as 0-13, 13-17, and 17 and up. If one of the occupants 210 is a child, the ECU 106 can compare the parental rating of the media that is currently playing in the vehicle 102 (e.g., based on the media data in the external database 112) to the classification of the child (e.g., 0-13, 13-17, and 17 and up). The parental rating of the media may be stored in the external database 112. In examples, the media may be rated as G (all ages), PG (parental guidance suggested), PG-13 (not recommended for children under 13), R (not recommended for children under 17). If the media is rated as inappropriate for children of the same age as one of the occupants 210, then the ECU 106 may cause the media to pause playing and display a content warning 214. For example, the content warning 214 may display on the user interface 120 stating “WARNING! Media includes adult content. Would you like to change your media selection?” and allow the user to select “Yes” or “Disable Child Mode.” If the user rejects the recommendation, the occupancy-based media recommendation system 100 may disable the child mode and continue to play the adult media or adjust the volume of the adult media in the cabin zone of the child using directional and/or localized audio.

In other aspects, the occupancy-based media recommendation system 100 may integrate with the driver's device (e.g., mobile phone, laptop, etc.), such as user device 124 of FIG. 1, to determine media age ratings for the currently playing media. The occupancy-based media recommendation system 100 may determine (e.g., via the ECU 106) from the driver's device that the media is rated as inappropriate for children. For example, the driver may be playing music from a particular application using the user device 124, which may contain age rating data for the corresponding media.

In some aspects, the vehicle 102 may not be playing any media. However, the occupancy-based media recommendation system 100 may detect that there is a child in the vehicle. In this case, the occupancy-based media recommendation system 100 may prompt the user to play media rated for children. On the contrary, if there are no children detected in the vehicle, the occupancy-based media recommendation system 100 may prompt the user to play media rated for adults.

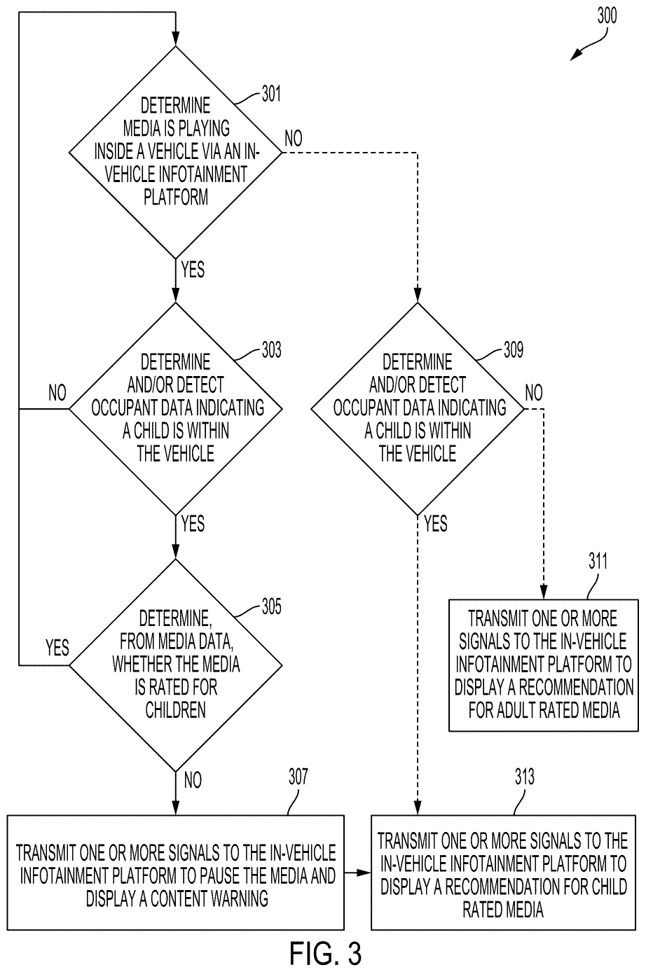

FIG. 3 is a flowchart illustrating a method 300 for recommending media based on a vehicle's occupants according to an aspect of the disclosure. One or more computers or one or more data processing apparatuses, for example, the ECU 106 of the occupancy-based media recommendation system 100 of FIG. 1, appropriately programmed, may implement the method 300. The method 300 of the disclosure, however, is not limited to use of the occupancy-based media recommendation systems of FIGS. 1-2.

The method 300 begins at block 301 where the occupancy-based media recommendation system 100 may determine media is playing inside a vehicle 102 via an in-vehicle infotainment platform. The in-vehicle infotainment platform may be configured to play media (e.g., music) inside the vehicle.

When media is playing inside the vehicle 102 via the in-vehicle infotainment platform, the occupancy-based media recommendation system 100 may determine and/or detect occupant data indicating a child is within the vehicle 102 at block 303. The occupancy-based media recommendation system 100 may receive occupant data from one or more occupant sensors, which are configured to detect or determine occupant data indicating a classification of each occupant within the vehicle. The one or more occupant sensors may include one or more of a camera, a lidar sensor, a radar sensor, a sonar sensor, a seatbelt sensor, a weight sensor, and/or a pressure sensor.

When the occupancy-based media recommendation system 100 determines and/or detects occupant data indicating a child is not within the vehicle, the occupancy-based media recommendation system 100 may return to block 301 where it may further determine whether media is playing inside the vehicle 102 via the in-vehicle infotainment platform.

When the occupancy-based media recommendation system 100 determines and/or detects occupant data indicating a child is within the vehicle, the occupancy-based media recommendation system 100 may determine, from media data, whether the media that is playing in the vehicle 102 is rated for children at block 305. The occupancy-based media recommendation system 100 may receive media data corresponding to the media playing inside the vehicle from a media database (e.g., external database 112). The media database may store age ratings for media playable via the in-vehicle infotainment platform. The occupancy-based media recommendation system 100 may use a network access device to facilitate communication between the media database and the vehicle 102.

When the occupancy-based media recommendation system 100 determines, from the media data, that the media that is playing in the vehicle 102 is not rated for children, the occupancy-based media recommendation system 100 may transmit one or more signals to the in-vehicle infotainment platform to pause the media and display a content warning at block 311. The content warning may prompt a passenger of the vehicle to change the media playing inside the vehicle to media rated for children. The occupancy-based media recommendation system 100 may receive a response to the prompt from the passenger to change the media playing inside the vehicle to media rated for children and transmit one or more signals to the in-vehicle infotainment platform to change the media playing inside the vehicle to media rated for children. In addition, the occupancy-based media recommendation system 100 may transmit one or more signals to the in-vehicle infotainment platform to display a recommendation for child rated media at block 313.

In examples, the occupancy-based media recommendation system 100 may alternatively or in addition, transmit one or more signals to the in-vehicle infotainment platform to adjust the volume of the media playing inside the vehicle after determining the media is not rated for children. In one aspect, the one or more occupant sensors are further configured to detect or determine occupant data indicating a location of each occupant within the vehicle. Therefore, the occupancy-based media recommendation system 100 may transmit one or more signals to the in-vehicle infotainment platform to adjust the volume of the media playing inside the vehicle based on the location of each occupant within the vehicle. For example, the occupancy-based media recommendation system 100 may lower the volume of the media in areas where the children are sitting in the vehicle.

When the occupancy-based media recommendation system 100 determines, from media data, that the media that is playing in the vehicle 102 is rated for children, the occupancy-based media recommendation system 100 may return to block 301 where it may further determine whether media is playing inside the vehicle 102 via the in-vehicle infotainment platform.

Optionally, when media is not playing inside the vehicle 102 via the in-vehicle infotainment platform, the occupancy-based media recommendation system 100 may determine and/or detect occupant data indicating a child is within the vehicle 102 at block 309.

Optionally, when the occupancy-based media recommendation system 100 determines and/or detects occupant data indicating a child is not within the vehicle, the occupancy-based media recommendation system 100 may transmit one or more signals to the in-vehicle infotainment platform to display a recommendation for adult rated media at block 311. For example, the occupancy-based media recommendation system 100 may display an alert in the user interface 120 recommending adult rated media for the passengers of the vehicle 102.

Optionally, when the occupancy-based media recommendation system 100 determines and/or detects occupant data indicating a child is within the vehicle, the occupancy-based media recommendation system 100 may transmit one or more signals to the in-vehicle infotainment platform to display a recommendation for child rated media at block 313. For example, the occupancy-based media recommendation system 100 may display an alert in the user interface 120 recommending child rated media for the passengers of the vehicle 102.

Exemplary aspects or embodiments of the invention have been disclosed in an illustrative style. Accordingly, the terminology employed throughout should be read in a non-limiting manner. Although minor modifications to the teachings herein will occur to those well versed in the art, it shall be understood that what is intended to be circumscribed within the scope of the patent warranted hereon are all such aspects or embodiments that reasonably fall within the scope of the advancement to the art hereby contributed, and that that scope shall not be restricted, except in light of the appended claims and their equivalents.

What is claimed is:

1. An occupancy-based media recommendation system for a vehicle, the system comprising:
one or more occupant sensors configured to detect or determine occupant data indicating a classification of each occupant within the vehicle, the classification being an adult or a child;
an in-vehicle infotainment platform configured to play media inside the vehicle;
a media database storing age ratings for media playable via the in-vehicle infotainment platform;
a network access device configured to facilitate communication between the media database and the vehicle; and
an electronic control unit (ECU) electrically connected to the one or more occupant sensors, the in-vehicle infotainment platform, and the network access device and configured to:
determine media is playing inside the vehicle via the in-vehicle infotainment platform,
receive the occupant data from the one or more occupant sensors,
determine the occupant data indicates a child is inside the vehicle,
receive media data, via the network access device, from the media database corresponding to the media playing inside the vehicle,
upon determining a child is inside the vehicle, determine, from the media data, whether the media is rated for adults, and
when the media is rated for adults, transmit one or more signals to the in-vehicle infotainment platform to pause the media and display a content warning.

2. The system of claim 1, wherein the content warning may prompt a passenger of the vehicle to change the media playing inside the vehicle to media rated for children.

3. The system of claim 2, wherein the ECU is further configured to:
receive a response to the prompt from the passenger to change the media playing inside the vehicle to media rated for children; and
transmit one or more signals to the in-vehicle infotainment platform to change the media playing inside the vehicle to media rated for children.

4. The system of claim 1, wherein the ECU is further configured to:
transmit one or more signals to the in-vehicle infotainment platform to adjust the volume of the media playing inside the vehicle.

5. The system of claim 1, wherein the one or more occupant sensors are further configured to detect or determine occupant data indicating a location of each occupant within the vehicle.

6. The system of claim 5, wherein the ECU is further configured to:
transmit one or more signals to the in-vehicle infotainment platform to adjust the volume of the media playing inside the vehicle based on the location of each occupant within the vehicle.

7. The system of claim 1, wherein the ECU is further configured to:
determine media is not playing inside the vehicle via the in-vehicle infotainment platform; and
upon determining a child is inside the vehicle, transmit one or more signals to the in-vehicle infotainment platform to display a prompt recommending media rated for children.

8. The system of claim 1, wherein the ECU is further configured to:
determine media is not playing inside the vehicle via the in-vehicle infotainment platform; and
upon determining a child is not inside the vehicle, transmit one or more signals to the in-vehicle infotainment platform to display a prompt recommending media rated for adults.

9. The system of claim 1, wherein the one or more occupant sensors include one or more of a camera, a lidar sensor, a radar sensor, a sonar sensor, a seatbelt sensor, a weight sensor, and/or a pressure sensor.

10. A vehicle including an occupancy-based media recommendation system, the vehicle comprising:
one or more occupant sensors configured to detect or determine occupant data indicating a classification of each occupant within the vehicle;
an in-vehicle infotainment platform configured to play media inside the vehicle;
a media database storing age ratings for media; and
an electronic control unit (ECU) electrically connected to the one or more occupant sensors, the in-vehicle infotainment platform, and the media database and configured to:
determine media is playing inside the vehicle via the in-vehicle infotainment platform,
receive the occupant data from the one or more occupant sensors,
determine the occupant data indicates a child is inside the vehicle,
upon determining a child is inside the vehicle, determine, from the media database, whether the media is rated for adults,
when the media is rated for adults, transmit one or more signals to the in-vehicle infotainment platform to pause the media and prompt a user to change the media to media rated for children,
receive a response to the prompt from the user to change the media to media rated for children, and
transmit one or more signals to the in-vehicle infotainment platform to change the media to media rated for children.

11. The vehicle of claim 10, wherein the ECU is further configured to:
transmit one or more signals to the in-vehicle infotainment platform to adjust the volume of the media in the vehicle.

12. The vehicle of claim 10, wherein the one or more occupant sensors are further configured to detect or determine occupant data indicating a location of each occupant within the vehicle.

13. The vehicle of claim 12, wherein the ECU is further configured to:
transmit one or more signals to the in-vehicle infotainment platform to adjust the volume of the media in the vehicle based on the location of each occupant within the vehicle.

14. The vehicle of claim 10, wherein the ECU is further configured to:
determine media is not playing inside the vehicle via the in-vehicle infotainment platform; and
upon determining a child is inside the vehicle, transmit one or more signals to the in-vehicle infotainment platform to display a prompt recommending media rated for children.

15. The vehicle of claim 10, wherein the ECU is further configured to:
determine media is not playing inside the vehicle via the in-vehicle infotainment platform; and
upon determining a child is not inside the vehicle, transmit one or more signals to the in-vehicle infotainment platform to display a prompt recommending media rated for adults.

16. The vehicle of claim 10, wherein the one or more occupant sensors include one or more of a camera, a lidar sensor, a radar sensor, a sonar sensor, a seatbelt sensor, a weight sensor, and/or a pressure sensor.

17. A method for recommending media in a vehicle based on occupancy of the vehicle, the method comprising:
detecting or determining, via one or more occupant sensors, occupant data indicating a classification of occupants within the vehicle;
determining, via an electronic control device (ECU) electrically connected to the one or more occupant sensors and an in-vehicle infotainment platform, whether media is playing inside the vehicle;
determining, via the ECU, whether a child is inside the vehicle from the classification of occupants in the occupant data;
upon determining a child is inside the vehicle, determining, from a media database, whether the media is rated for adults; and
when the media is rated for adults, transmitting one or more signals to the in-vehicle infotainment platform to pause the media and display a content warning.

18. The method of claim 17, wherein the content warning may prompt a passenger of the vehicle to change the media to media rated for children.

19. The method of claim 18, further comprising:
receiving a response to the prompt from the passenger to change the media to media rated for children; and
transmitting one or more signals to the in-vehicle infotainment platform to change the media to media rated for children.

20. The method of claim 17, further comprising:
transmitting one or more signals to the in-vehicle infotainment platform to adjust the volume of the media in the vehicle.
